(19) United States
(12) Patent Application Publication
(10) Pub. No.: US 2003/0132058 A1
(43) Pub. Date: Jul. 17, 2003

(54) Ladder stabilizing device

(76) Inventor: Michael R. Pollock, Boise, ID (US)

Correspondence Address: DYKAS, SHAVER & NIPPER, LLP, P O BOX 877, BOISE, ID, 83701-0877, US

(21) Appl. No.: 10/052,153

(22) Filed: Jan. 16, 2002

(51) Int. Cl. E06C 1/00

(52) U.S. Cl. 182/25

(57) ABSTRACT

A ladder safety crosspiece for inhibiting the diagonal movement of opposite (diagonal) legs of opposing rails of a stepladder. The crosspiece has a pair of crossing pliable stabilizers which extend between these diagonal legs, are taut as the side spacers of the ladder are locked, and which fold out of the way when the side spacers of the ladder are not locked and the ladder is folded.

### DESCRIPTION

### BACKGROUND OF THE INVENTION

1. Field of the Invention

The present invention generally relates to ladders, and more particularly to ladders and attachments for ladders which decrease dangerous twisting and walking of the ladder while a user is using said ladder.

2. Background Information

A major problem with the use of ladders, particularly what is known in the industry as “stepladders,” is what the inventor calls “ladder walk.” Ladder walk is the process whereby the first rail and the second rail of the ladder move out of alignment with one another, thereby causing the ladder to become extremely unstable. What happens is that as the user shifts his/her weight back and forth while working, the legs on the side of the ladder which is opposite to the side of the ladder the user is standing tend to lift off the ground surface and move laterally. Thus, the ladder flexes resulting in only three of the four legs resting upon the ground surface. Used in such a manner, the ladder becomes very unstable.

As the user removes or shifts his/her weight on and off the ladder, the ladder itself snaps back to a position near the default resting position. As this process takes place over time, the ladder tends to gradually “walk” right out from under the user, causing a potential for great injury. This situation can be best explained in reference to FIG. 1 and FIG. 2.

FIG. 1 shows a stepladder's default position. In this position, a first rail having a left leg 18 and a right leg 20 opposes a second rail having a left leg 26 and a right leg 28. In such a default position, the diagonal measurement X between the first rail left leg and the second rail right leg would generally be equal to the diagonal measurement Y between the second rail left leg and the first rail right leg.

FIG. 2 shows the stepladder of FIG. 1 where the stepladder is walking. When walking, the second rail typically slightly twists so that the diagonal measurement X′ is greater than the diagonal measurement Y′ (or vise versa). In this example, leg 18 is now further from leg 28, and leg 26 would be closer to leg 20 than when at rest (FIG. 1). In such a configuration, leg 28 would probably not be touching the ground surface, whereas the other three legs would be.

There are many different ladder accessory devices which have been invented to make a ladder more stable. U.S. Pat. No. 6,116,379 to Huss describes many of these prior art devices. Huss itself describes a ladder stabilizing cross brace comprising a rigid cross piece which is located near the base of the ladder, which folds sideways when the ladder is folded. The Huss ladder stabilizing cross brace has a compound folding means with a hinge to assist such folding. The Huss device extends only between one of the opposing diagonal rails of the ladder it is used upon. The Huss device is also not able to compensate for wear and loose tolerances in the ladder.

None of the prior art inventions disclose a ladder-stabilizing device which can easily be added to existing ladders, and/or be built into new ladders. It would be useful for the device to not interfere with the usual operation of the ladder, particularly the folding and unfolding of the ladder (if folding is an option on the ladder). It would also be useful for the device to not require any activity on the part of the user in order to engage the device. It would also be useful to reduce the wear on the ladder caused by “walking” and thus extend its life span. Essentially, what is needed is an automatic engaging and disengaging ladder safety device. The present invention solves this problem.

### SUMMARY OF THE INVENTION

The present invention is a stabilizing device for use on a ladder. It works by keeping the diagonal legs of the ladder from moving away from/or towards one another. The invented device is particularly useful on stepladders. Stepladders typically have a first rail having a top end, a left leg and a right leg, and a second rail having a top end, a left leg and a right leg. Stepladders typically also have at least one pivot means for pivotally mounting the first rail top end section in relation to the second rail top end section, or vice versa. Many stepladders sold today have a first side spacer linking the first rail left leg to the second rail left leg, and a second side spacer linking the first rail right leg to the second rail right leg. These first and second side spacers are able to move from a first unlocked position to a second locked position thereby moving the stepladder from a folded position to an unfolded position.

One embodiment of the invented stabilizing device has a first rail left leg attachment means located on the stepladder's first rail left leg, this attachment means for allowing connection between said first rail left leg and a first pliable stabilizer first end. This embodiment also having a first rail right leg attachment means located on the first rail right leg, the first rail right leg attachment means for allowing connection between the first rail right leg and a second pliable stabilizer first end. This embodiment also having a second rail left leg attachment means located on the second rail left leg, the second rail left leg attachment means for allowing connection between the second rail left leg and a second pliable stabilizer second end. This embodiment also having a second rail right leg attachment means located on the second rail right leg, the second rail right leg attachment means for allowing connection between the second rail right leg and a first pliable stabilizer second end.

The first pliable stabilizer has a first end and a second end, and is for inhibiting movement of the first rail left leg away from the second rail right leg when the side spacers are in their locked position. Likewise, the second pliable stabilizer has a first end and a second end, and is for inhibiting movement of the second rail left leg away from the first rail right leg when the side spacers are in their locked position. The first pliable stabilizer first end attaches to the first rail left leg attachment means and the first pliable stabilizer second end attaches to the second rail right leg attachment means. The second pliable stabilizer first end attaches to the first rail right leg attachment means, and the second pliable stabilizer second end attaches to the second rail left leg attachment means.

The length of the first pliable stabilizer is generally equal to the distance between the first rail left leg attachment means and the second rail right leg attachment means when the side spacers are in their locked position. The length of the second pliable stabilizer is generally equal to the distance between the second rail left leg attachment means and the first rail right leg attachment means when the side spacers are in their locked position.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a schematic view of the footprint of a ladder in its default resting state.

FIG. 2 is a schematic view of the footprint of a ladder being used in a twisting or walking situation.

FIG. 3 is a side perspective view of one embodiment of the present invention.

FIG. 4 is a sequential, side perspective view of the embodiment of FIG. 3.

FIG. 5 is a partial, side perspective view of the embodiment of FIG. 3.

FIG. 6 is a partial, side perspective view of a first rail connection embodiment utilized with the present invention.

FIG. 7 is a partial, side perspective view of a second rail connection embodiment utilized with the present invention.

FIG. 8 is a side view of the first rail connection of FIG. 6.

FIG. 9 is a side view of the second rail connection of FIG. 7.

FIG. 10 is an environmental, cross-sectional view of the first rail connection of FIG. 6, shown installed on a ladder rail.

FIG. 11 is an environmental, cross-sectional view of another rail connection embodiment, shown installed on a ladder rail.

FIG. 12 is a perspective view of another rail connection embodiment.

FIG. 13 is a side view of a third rail connection.

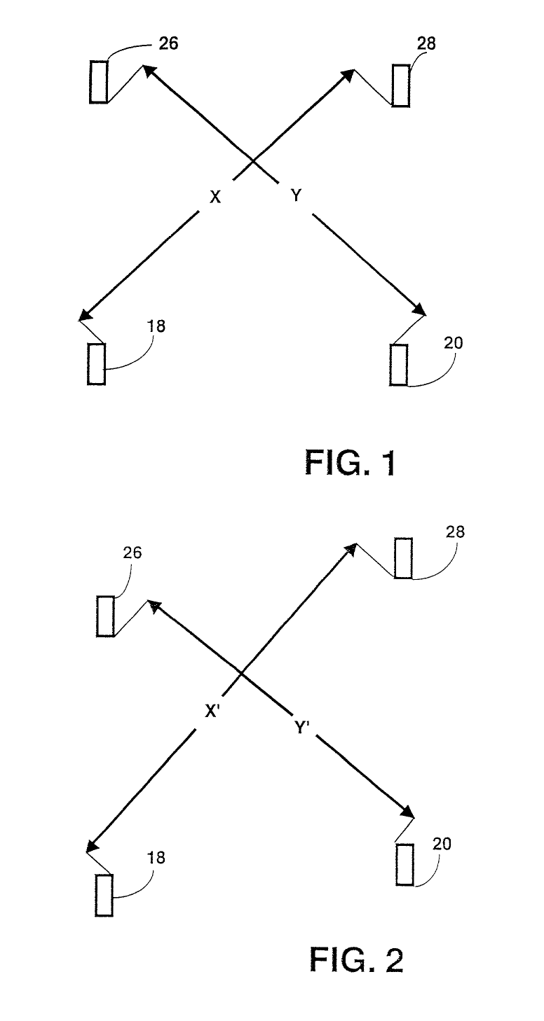

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

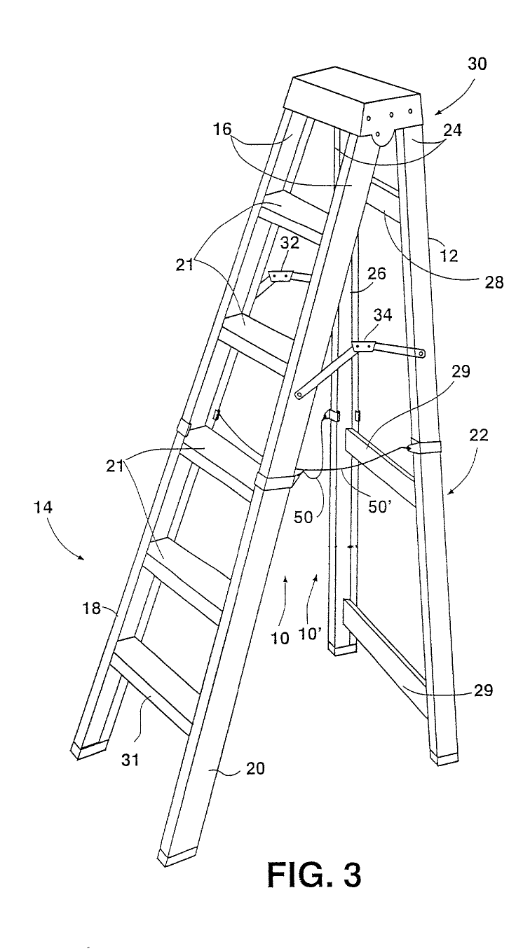

The present invention is a stabilizing device for use on or with a ladder. Referring to the embodiment shown in FIG. 3, a pair of the stabilizing devices 10 (10′) are shown installed and in their disengaged state, as the ladder 12 shown in FIG. 3 is partially folded. The stabilizing device 10 (10′) would remain in its disengaged state if the ladder was fully folded. It is preferred that a pair of the stabilizing devices 10, 10′ be used together, each attaching to a different diagonal pair of legs. For all intents and purposes, within the preferred embodiment, the stabilizing devices 10, 10′ are identical in form and structure. Thus, discussion of one stabilizing device 10 is intended to include the other 10′.

This embodiment of stabilizing device 10 is intended for use upon a standard fiberglass, aluminum or other material ladder made of with U-shaped channel legs. Such type of ladders are common in the trade. Other types of ladders could also be improved with the present invention, for instance the wood ladder shown in cross-section in FIG. 13. The ladder 12 has a first rail 14 and second rail 22. The first rail 14 has a top end 16, a generally U-shaped channel left leg 18, and a generally U-shaped channel right leg 20. Extending between the left leg 18 and the right leg 20 is at least one step or divider 21. The second rail 22 has a top end 24, a generally U-shaped channel left leg 26, and a generally U-shaped channel right leg 28. The top ends (16, 24) of the first rail and second rail are attached through use of a pivot means 30, as is standard with traditional ladders. Extending between the left leg 26 and the right leg 28 is at least one step or divider 29.

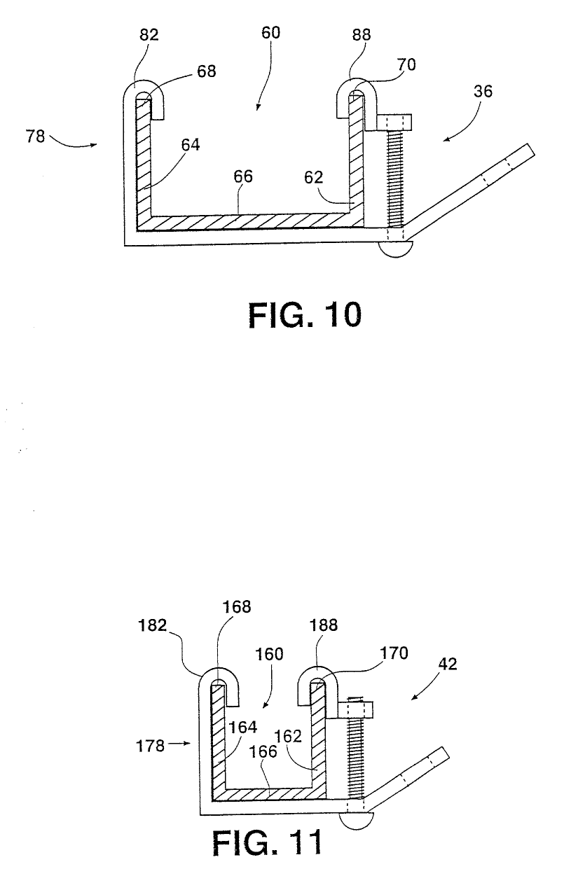

Such a U-shaped channel, whether it be on the first or second rails may have a number of different configurations. For instance, the channel 60′ may have one side shorter than a second side, or, as shown in FIG. 10, the channel 60 may have equal height sides 62, 64 attaching to a base 66, with each side having a rim 68, 70. The ladder shown in FIG. 3 uses a pair of side spacer braces to lock the ladder in its unfolded state. This first side spacer brace 32 and second side spacer brace 34 are shown in their default disengaged state, and are standard hardware found on many ladders made today. It can be seen in this figure that that in the disengaged or “unlocked position,” the stabilizing device's pliable stabilizers 50, 50′ are not taut, and offer no diagonal stabilization of the ladder.

While the embodiments reflected in the drawings and description of this application typically are of ladders having this two rail hinged configuration using side spacers to lock the rails a distance apart, it is likewise envisioned that other types of ladders may also be used with the features disclosed in this application, including, but not limited to, one-way stepladders, two-way stepladders, platform stepladders, and multi-purpose ladders.

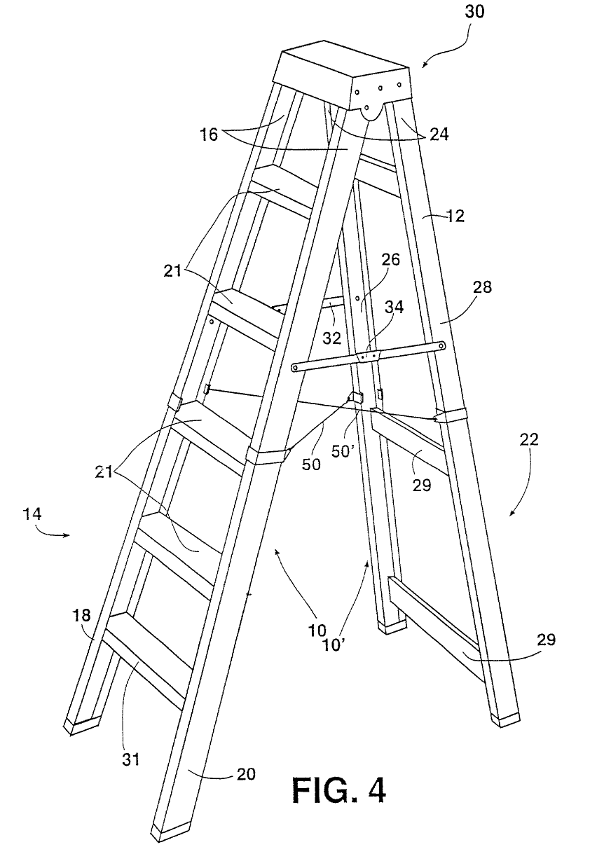

Referring to FIG. 4, the present invention 10, 10′ is shown installed on ladder 12 being shown in its locked state with the first side spacer brace 32 and the second side spacer brace 34 in their locked positions. It can be seen that in the “locked position,” the stabilizing device's pliable stabilizers 50, 50′ are taut, thereby stabilizing the ladder diagonally.

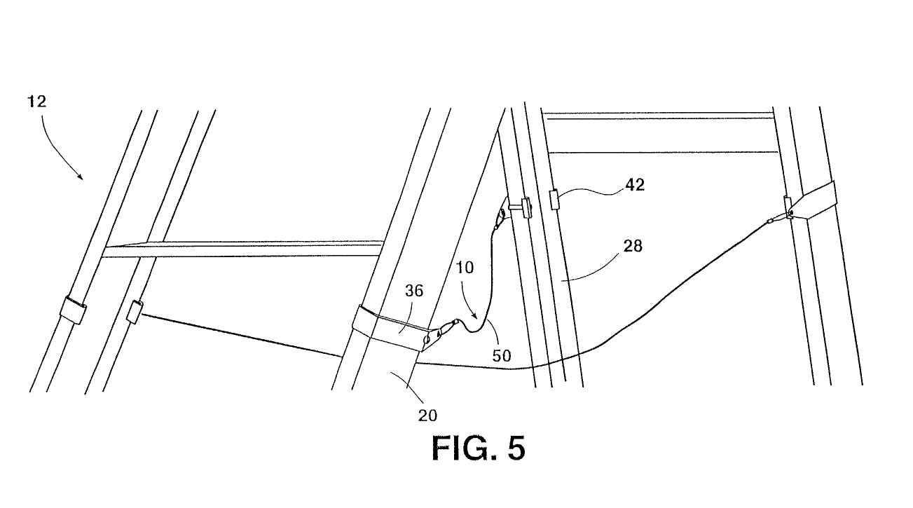

Referring now to FIG. 5, the preferred embodiment of the present invention 10 is shown in greater detail. The invented stabilizing device 10 is shown installed on a ladder, where the ladder 12 is in a partially folded state. If the ladder was in its extended and locked position, the pliable stabilizer 50 would be taut, as shown in FIG. 4. Referring back to FIG. 5, in this embodiment, a first attachment means 36 is able to interconnect the first rail right leg 20 to the pliable stabilizer 50. This pliable stabilizer 50 extends to a second attachment means 42 located on the second rail left leg 28.

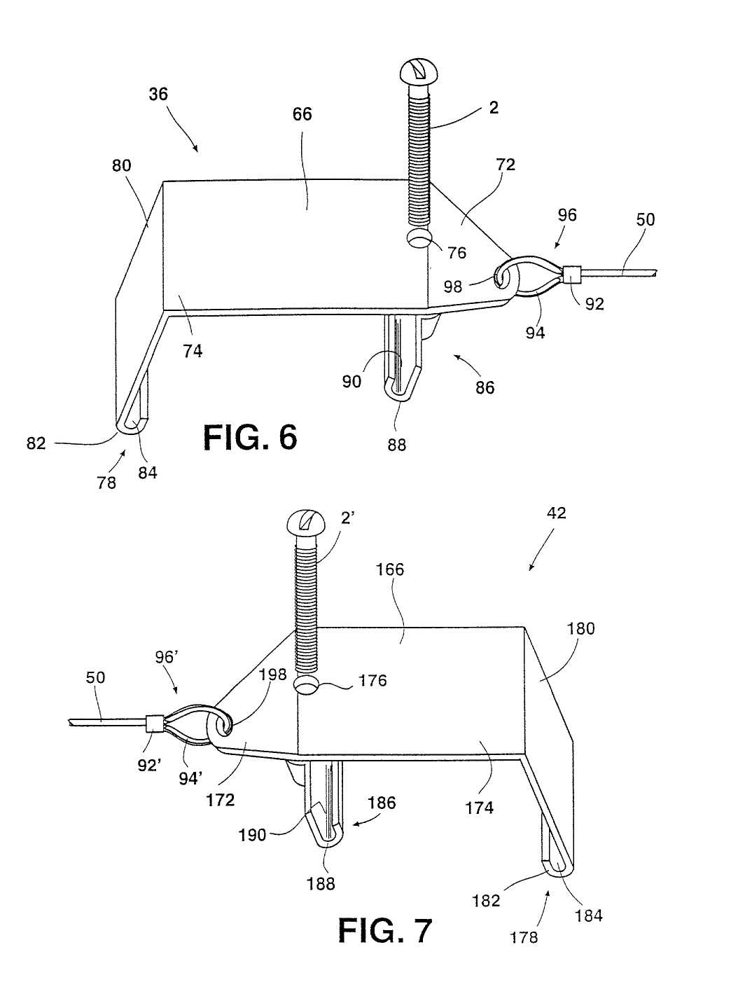

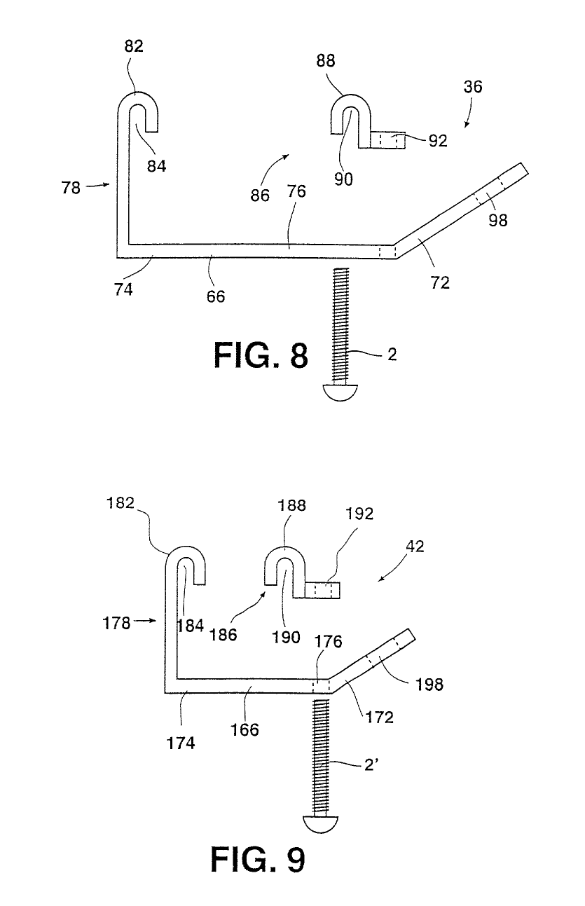

Referring now to FIGS. 6 and 8, the first attachment means has an elongated base 66 having a first end 72 and a second end 74. The first end 72 being configured for attachment to the pliable stabilizer. In the preferred embodiment, this configuration comprises a hole 98 through the first end for receiving an end of the pliable stabilizer. This pliable stabilizer end would then preferably be folded back towards the remainder of the pliable stabilizer, as shown in FIG. 6, creating a loop 96. It is preferred that a compression sleeve 94 be inserted into this loop and a standard crimp thimble 92 be used to fix the loop. Other means of attaching the pliable stabilizer to the present invention are also envisioned.

The second end 74 further comprises a first rim attachment means 78 for allowing the stabilizing device to attach to the channel of said ladder. In the preferred embodiment, this first rim attachment means 78 is a generally J-shaped piece, having a length between a blunt end 80 and a curved end 82. This blunt end 80 attaching to said second end 74 so that the length of said J-shape is generally perpendicular to said attachment means elongated base 66. The curved end 82 defining a groove 84, said groove for interlocking attachment to said first rim 68 (as shown in FIG. 10).

The stabilizing device further comprises a second rim attachment means 86 for allowing the stabilizing device to further attach to the channel of said ladder. This second rim attachment means 86 is able to attach to said elongated base 66 at or near said first end 72. The second rim attachment means 86 having defined therethrough a threaded orifice 92, able to receive a threaded bolt 2 therein. This threaded bolt 2 able to extend through the orifice 76 defined within the elongated base 66. The second rim attachment means 86 further defining a curved end 88 having a groove 90 for interlocking connection with said second rim, as shown in FIG. 10.

Referring now to FIGS. 7 and 9, the stabilizing device has an elongated base 166 having a first end 172 and a second end 174. The first end 172 being configured for attachment to the pliable stabilizer. In the preferred embodiment, this configuration comprises a hole 198 through the first end for receiving an end of the pliable stabilizer. This pliable stabilizer end would then preferably be folded back towards the remainder of the pliable stabilizer, creating a loop 96′, as shown in FIG. 7. It is preferred that a compression sleeve 94′ be inserted into this loop and a standard crimp thimble 92′ be used to fix the loop. Other means of attaching the pliable stabilizer to the present invention are also envisioned.

The second end 174 further comprises a first rim attachment means 178 for allowing the stabilizing device to attach to the channel of said ladder. In the preferred embodiment, this first rim attachment means 178 is a generally J-shaped piece, having a length between a blunt end 180 and a curved end 182. This blunt end 180 attaching to said second end 174 so that the length of said J-shape is generally perpendicular to said attachment means elongated base 166. The curved end 182 defining a groove 184, said groove for interlocking attachment to said first rim 168 (as shown in FIG. 11).

Referring back to FIG. 7, the stabilizing device further comprises a second rim attachment means 186 for allowing the stabilizing device to further attach to the channel of said ladder. This second rim attachment means attaching to said elongated base 166 at or near said first end 172. The second rim attachment means 186 having defined therethrough a threaded orifice 192, able to receive a threaded bolt 2′ therein. This threaded bolt 2′ able to extend through the orifice 176 defined within the elongated base 166. The second rim attachment means 186 further defining a curved end 188 having a groove 190 for interlocking connection with said second rim, as shown in FIG. 11.

Attachment of the preferred embodiment of the stabilizing device 10 to a ladder leg is done by wrapping the device in a nesting fashion around the channel back side with the rim of the far side being received into the groove of the first rim attachment means as shown in FIG. 10. The groove of the second rim attachment means could then be placed over the second rim and the threaded bolt tightened thereby drawing the second rim attachment means into a rigid connection with the second rim, thereby locking the stabilizing device first attachment means onto the ladder leg as shown in FIG. 10. Likewise attachment of the second attachment means would be done to a diagonal ladder leg (as shown in FIG. 11).

Adjustment of the present invention can be done by installing the present invention on a ladder in its unfolded, locked position and then sliding the device 10 downwards along the legs installed thereon so that the pliable stabilizer 44 is taught and then tightening the threaded bolt 2, 2′ or other fastening means.

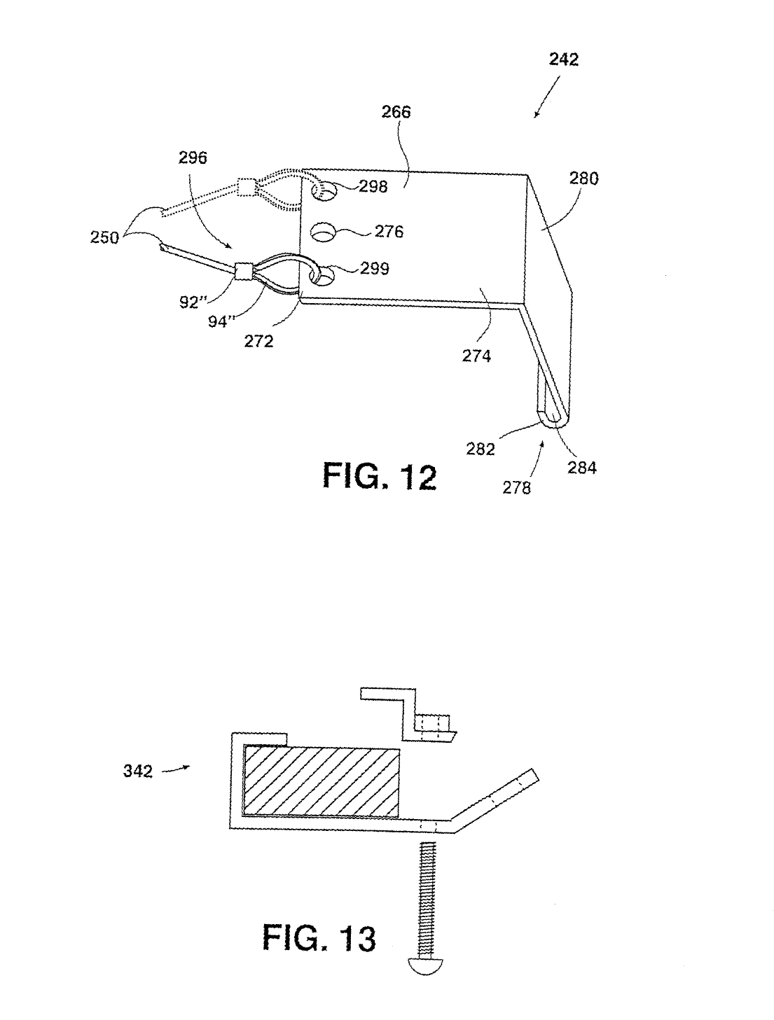

Now referring to FIG. 12, shown is an alternative embodiment for the attachment means 42 of the present invention. This alternative embodiment could be utilized for the first attachment means, the second attachment means or both. Shown is a second attachment means in the alternative configuration. The attachment means 242 has an elongated base 266 having a first end 272 and a second end 274. The first end 272 being configured for attachment to the pliable stabilizer. In the preferred embodiment, this configuration comprises at least one hole 298, 299 through the first end for receiving an end of the pliable stabilizer. In this embodiment, the hole 298, 299 is located adjacent the hole 276 for receiving and cooperating with the bolt (not shown). This pliable stabilizer end would then preferably be folded back towards the remainder of the pliable stabilizer, as shown in FIG. 6, creating a loop 296. It is preferred that a compression sleeve 294 be inserted into this loop and a standard crimp thimble 292 be used to fix the loop. Other means of attaching the pliable stabilizer to the present invention are also envisioned.

The second end 274 further comprises a first rim attachment means 278 for allowing the stabilizing device to attach to the channel of said ladder. In the preferred embodiment, this first rim attachment means 278 is a generally J-shaped piece, having a length between a blunt end 280 and a curved end 282. This blunt end 280 attaching to said second end 274 so that the length of said J-shape is generally perpendicular to said attachment means elongated base 266. The curved end 282 defining a groove 284, said groove for interlocking attachment to said first rim 268 (as shown in FIG. 10). The stabilizing device would likewise further comprises a second rim attachment means as shown in FIG. 6.

Referring now to FIG. 13, shown is an alternative embodiment of a rim attachment means 342 which could be used on a solid legged ladder, for instance a wood ladder.

Also envisioned is the ability to detach the invented device 10 when necessary, for instance if an object need to be straddled by the ladder which would contact the invented device. The bolt 2, 2′ shown would be one manner of making the invented device detachable.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A stabilizing device for use on a ladder, said ladder comprising a first rail having a top end, a first leg and a second leg, and a second rail having a top end, a first leg and a second leg, wherein said ladder further comprises a pivot means for pivotally mounting said first rail top end section in relation to said second rail top end section; wherein said ladder comprises a first side spacer linking said first rail first leg to said second rail first leg, and a second side spacer linking said first rail second leg to said second rail second leg, said first and second side spacers able to move from a first unlocked position to a second locked position thereby moving said ladder from a folded position to an unfolded position, said ladder legs comprising generally U-shaped channels; wherein said stabilizing device comprises:
a first leg attachment means configured for attachment to said first rail first leg;
a second leg attachment means configured for attachment to said second rail second leg;
a pliable stabilizer having a first end and a second end, said pliable stabilizer for inhibiting movement of said first rail first leg away from said second rail second leg when said side spacers are in their locked position;
wherein said first rail first leg attachment means for allowing connection between said first rail first leg and said pliable stabilizer first end, wherein said first rail first leg attachment means comprises a generally U-shaped connection means able to receive therein and connect thereto said generally U-shaped first rail first leg channel;
wherein said second rail second leg attachment means for allowing connection between said second rail second leg and said pliable stabilizer second end, wherein said second rail second leg attachment means comprises a generally U-shaped connection means able to receive therein and connect thereto said generally U-shaped second rail second leg channel;
wherein said pliable stabilizer first end attaches to said first leg attachment means;
wherein said pliable stabilizer second end attaches to said second leg attachment means; and
wherein the length of the first pliable stabilizer is generally equal to the distance between said first leg attachment means and said second leg attachment means when said side spacers are in their locked position.

2. A stabilizing device for use on a ladder, said ladder comprising a first rail having a top end, a left leg and a right leg, and a second rail having a top end, a left leg and a right leg, wherein said ladder further comprises a pivot means for pivotally mounting said first rail top end section in relation to said second rail top end section; wherein said ladder comprises a first side spacer linking said first rail left leg to said second rail left leg, and a second side spacer linking said first rail right leg to said second rail right leg, said first and second side spacers able to move from a first unlocked position to a second locked position thereby moving said ladder from a folded position to an unfolded position, said ladder legs comprising generally U-shaped channels, wherein said stabilizing device comprises:
a first rail left leg attachment means configured for attachment to said first rail left leg, said first rail left leg attachment means for allowing connection between said first rail left leg and a first pliable stabilizer first end, wherein said first rail left leg attachment means comprises a generally U-shaped connection means able to receive therein and connect thereto said generally U-shaped first rail left leg channel;
a first rail right leg attachment means configured for attachment to said first rail right leg, said first rail right leg attachment means for allowing connection between said first rail right leg and a second pliable stabilizer first end, wherein said first rail right leg attachment means comprises a generally U-shaped connection means able to receive therein and connect thereto said generally U-shaped first rail right leg channel;
a second rail left leg attachment means configured for attachment to said second rail left leg, said second rail left leg attachment means for allowing connection between said second rail left leg and a second pliable stabilizer second end, wherein said second rail left leg attachment means comprises a generally U-shaped connection means able to receive therein and connect thereto said generally U-shaped second rail left leg channel;
a second rail right leg attachment means configured for attachment to said second rail right leg, said second rail right leg attachment means for allowing connection between said second rail right leg and a first pliable stabilizer second end, wherein said second rail right leg attachment means comprises a generally U-shaped connection means able to receive therein and connect thereto said generally U-shaped second rail right leg channel;
a first pliable stabilizer having a first end and a second end, said first pliable stabilizer for inhibiting movement of said first rail left leg away from said second rail right leg when said side spacers are in their locked position;
a second pliable stabilizer having a first end and a second end, said second pliable stabilizer for inhibiting movement of said second rail left leg away from said first rail right leg when said side spacers are in their locked position;
wherein said first pliable stabilizer first end attaches to said first rail left leg attachment means;
wherein said first pliable stabilizer second end attaches to said second rail right leg attachment means;
wherein said second pliable stabilizer first end attaches to said first rail right leg attachment means;
wherein said second pliable stabilizer second end attaches to said second rail left leg attachment means;
wherein the length of the first pliable stabilizer is generally equal to the distance between said first rail left leg attachment means and said second rail right leg attachment means when said side spacers are in their locked position; and
wherein the length of the second pliable stabilizer is generally equal to the distance between said second rail left leg attachment means and said first rail right leg attachment means when said side spacers are in their locked position.

3. The stabilizing device of claim 2, wherein said first rail left leg attachment means is generally parallel to said first rail right leg attachment means.

4. The stabilizing device of claim 2, wherein said second rail left leg attachment means is generally parallel to said second rail right leg attachment means.

5. The stabilizing device of claim 2, wherein said pliable stabilizers are lengths of wire cable.

6. A ladder attachment clamp for use in a ladder safety device, said clamp configured for attachment to one leg of a ladder, said ladder having at least one leg having a generally U-shaped channel having a pair of sides attaching to a base with each side having a rim, wherein said clamp comprises:
a rail attachment means having an elongated base having a first end and a second end, wherein said first end further defines a first pliable stabilizer attachment allowing the first attachment means to be attached to a pliable stabilizer, wherein said second end comprises a first rim attachment means for allowing the stabilizing device to attach to the channel of said first leg of said ladder first rail, said first rim attachment means being generally J-shaped, having a length between a blunt end and a first curved end, wherein said blunt end is configured for attachment to said second end so that the length of said J-shape is generally perpendicular to said attachment means elongated base, said curved end defining a first groove, said groove for interlocking attachment to said first rim of said channel of said leg of said ladder first rail, said first attachment means further comprising a second rim attachment means for allowing the stabilizing device to further attach to said channel of said first leg, said second rim attachment means able to attach to said elongated base at or near said first end, said second rim attachment means having defined therethrough a threaded orifice able to receive a threaded bolt therein, said threaded bolt able to extend through a second orifice defined within said elongated base, said second rim attachment means further defining a second curved end having a second groove for interlocking connection with said second rim.
